(19) United States
(12) Patent Application Publication
(10) Pub. No.: US 2021/0075750 A1
(43) Pub. Date: Mar. 11, 2021

(54) METHOD FOR CONTROLLING DISPLAY OF A CONSULTATION SESSION

(71) Applicant: MINDS LAB INC., Daejeon (KR)

(72) Inventors: Tae Joon YOO, Incheon (KR); Dong Su KIM, Gyeonggi-do (KR); Hong Seop CHOI, Gyeonggi-do (KR)

(73) Assignee: MINDS LAB INC., Daejeon (KR)

(21) Appl. No.: 17/014,125

(22) Filed: Sep. 8, 2020

(30) Foreign Application Priority Data
Sep. 9, 2019 (KR) 10-2019-0111551

(51) Int. Cl. H04L 12/58; G06Q 30/00; G06Q 50/10; G06Q 30/02

(52) U.S. Cl. CPC H04L 51/02; G06Q 30/016; G06Q 30/0281; H04L 51/16; G06Q 50/10

(57) ABSTRACT

Provided is a method of controlling display of a consultation session by integrating and displaying at least one consultation session managed by an individual respondent. The method includes receiving, from a server, data about the at least one consultation session to be displayed; displaying a consultation session window for each of the at least one consultation session; and displaying in a preset manner a session window of a consultation session in which details of consultation satisfy a certain condition for a consultant's intervention. The consultation session window includes a history of conversation in each of the at least one consultation session.

### CROSS-REFERENCE TO RELATED APPLICATION

This application is based on and claims priority under 35 U.S.C. § 119 to Korean Patent Application No. 10-2019-0111551, filed on Sep. 9, 2019, in the Korean Intellectual Property Office, the disclosure of which is incorporated by reference herein in its entirety.

### BACKGROUND

### 1. Field

Embodiments relate to a method of controlling display of a consultation session by integrating information about at least one consultation session managed by an individual respondent and displaying a result of the integration to a consultant.

### 2. Description of Related Art

Consumers who have purchased various types of products, such as electronic products, financial products, travel products, vouchers of services, or the like, call contact centers (or consultation centers) of the manufacturers or retailers of the products or services when they have an inquiry about the products or services or when the products or services have a defect or malfunction.

Most companies operate such a consultation center to answer or handle consumers' complaints or inquiries. It is convenient for consumers to be provided with services through operation of a consultation center but it is burdensome for companies in terms of costs due to the large number of staff in the consultation center.

When calling the consultation center, consumers may feel inconvenience in explaining their inquiry several times when talking with a consultant.

### SUMMARY

Embodiments are directed to integrating information related to consultation and providing a consultant with a result of the integration to use resources of a consultation center more efficiently and to enable the consultant to conduct consultation effectively.

Embodiments are directed to providing a history of conversation with previous consultation targets to minimize any inconvenience, which may be caused to a user due to duplicate consultation, when consultation is conducted with respect to various consultation targets in one consultation session.

Embodiments are directed to providing information related to a user's psychological state and the like to a consultant through a history of conversation and providing relevant information in real time according to the history of conversation, so that consultation may be conducted effectively and intensively and conducted to meet the user's need.

Embodiments are directed to monitoring a plurality of consultation sessions by a consultant, and in particular, displaying a consultation session window by giving visual effects thereto according to levels of need for intervention in a plurality of consultation sessions, thereby enabling the consultant to efficiently monitor the plurality of consultation sessions.

Embodiments are directed to providing an interface for quickly inputting a pre-completed phrase with respect to a consultant's intervention in a consultation session, thereby preventing a delay in consultation due to a change of a respondent.

Additional aspects will be set forth in part in the description which follows and, in part, will be apparent from the description, or may be learned by practice of the presented embodiments of the disclosure.

According to one or more embodiments, there is provided a method of controlling display of a consultation session by integrating and displaying at least one consultation session managed by an individual respondent, the method including receiving data about the at least one consultation session to be displayed from a server; displaying a consultation session window for each of the at least one consultation session, the consultation session window including a history of conversation in each of the at least one consultation session; and displaying in a preset manner a session window of a consultation session in which details of consultation satisfy a certain condition for a consultant's intervention.

The method may further include performing processing for the consultant's intervention in a selected consultation session, based on information regarding the consultant's selection of one of the at least one consultation session. The performing of processing for the consultant's intervention may include requesting the server to transmit a message providing notification of the consultant's intervention to at least one of a respondent and a user who participate in the selected consultation session; displaying timing of the consultant's intervention on a conversation window of the selected consultation session; and displaying an interface for the consultant's participation in the selected consultation session.

The performing of processing for the consultant's intervention may further include transmitting, to the server, an instruction instructing the respondent to end answering to the user.

The displaying of the consultation session window may include displaying a consultation session display window for each of the at least one consultation session such that at least some areas of the consultation session are not hidden by other windows.

The displaying of the session window of the consultation session in the preset manner may include checking a level of need for the consultant's intervention in each of the at least one consultation session; and emphasizing and displaying a session window of a consultation session with a higher need for the consultant's intervention.

The emphasizing and displaying of the session window of the consultation session with the higher need for the consultant's intervention may include displaying the session window of the consultation session with the higher need for the consultant's intervention by displaying the session window to be larger, displaying the session window at a highest layer, displaying the session window at the front, or blinking the session window.

The condition for the consultant's intervention may include a condition in which a level of need for the consultant's intervention is equal to or greater than a certain threshold.

The displaying of the consultation session window may include displaying, on the consultation session window, at least one of identification information of a user participating in the at least one consultation session, information obtained by analyzing the history of conversation, and additional information of the user, as well as the history of conversation in each of the at least one consultation session.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram schematically illustrating a configuration of a consultation system according to an embodiment;

FIG. 2 is a diagram schematically illustrating a configuration of a consultant terminal according to an embodiment;

FIG. 3 is a flowchart for explaining a method of controlling display of a consultation session conducted using a consultant terminal according to an embodiment;

FIG. 4 is a diagram illustrating a screen displayed on a consultant terminal, the screen including three consultation session windows;

FIG. 5 illustrates an example of a screen displaying an interface for a consultant's participation in a session; and

FIG. 6 illustrates another example of a screen displaying an interface for a consultant's participation in a session.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The disclosure may be embodied in many different forms and performed in various embodiments. Thus, certain embodiments are illustrated in the drawings and described in detail herein. Advantages and features of the disclosure and methods of achieving them will be apparent from embodiments described below in detail, in conjunction with the accompanying drawings. However, the disclosure is not limited to these embodiments and may be embodied in many different forms.

Hereinafter, embodiments will be described in detail with reference to the accompanying drawings, and the same or corresponding components are assigned the same reference numbers and are not redundantly described herein.

In the following embodiments, terms such as first and second are not used for purpose of limitation but are used to distinguish one element from other elements. In the following embodiments, the singular expressions are intended to include plural forms as well, unless the context clearly dictates otherwise. In the following embodiments, terms such as include or have means that the features or components described in the specification are present, and do not preclude the possibility that one or more other features or components may be added. In the drawings, elements may be exaggerated or reduced in size for convenience of description. For example, the size and shape of each element are arbitrarily illustrated in the drawings for convenience of description and thus the disclosure is not necessarily limited thereto.

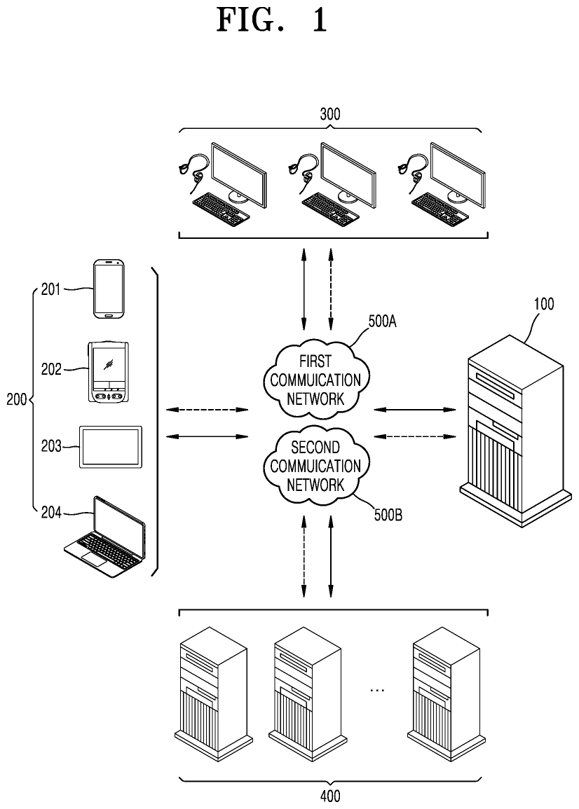

FIG. 1 is a diagram schematically illustrating a configuration of a consultation system according to an embodiment.

Referring to FIG. 1, a consultation system according to an embodiment may include a server 100, a user terminal 200, a consultant terminal 300, a chatbot server 400, a first communication network 500A, and a second communication network 500B.

The consultation system according to an embodiment may handle a consultation session for a user through continuously changing at least one of a respondent and a communication method for consultation during the handling of the consultation session for the user. For example, in one embodiment, the consultation system may switch a communication method of a consultation session for a user from a chat method to a call method or vice versa and switch a respondent of the consultation session from a chatbot to a consultant or vice versa.

In one embodiment, the consultation system may provide a consultant with a history of conversations with a user and information obtained by analyzing the user according to the history of conversations during handling of a consultation session for the user by the consultant, thereby guaranteeing effective and smooth consultation.

In addition, in one embodiment, the consultation system may integrate at least one consultation session managed by a chatbot and/or a consultant and provide the consultant with a result of the integration.

As used herein, a ‘consultation session’ for a user may refer to a unit in which details of consultation with the user are handled and managed. For example, in the case of a consultation center of a financial service provider, a consultation session for a user who wants to cancel a certain product may include a series of operations of canceling the product, a result of analyzing messages from the user, and the like. However, the above description is merely an example and the scope of the disclosure is not limited thereto.

As used herein, a ‘consultation center’ may refer to a place and/or facility where various services are provided to remote users. For example, the consultation center may be understood to include a ‘customer center’, a ‘call center’, a ‘common service (CS) center’, and the like in a traditional sense. However, the above description is only an example and the scope of the disclosure is not limited thereto.

As used herein, a ‘user’ may refer to a subject that transmits his or her request to a consultation center as described above and receives an appropriate response or service to the request. For example, when a consultation center is operated by a financial service provider, a user may be a subscriber who has subscribed to or wants to subscribe to a financial product provided by the financial service provider. However, the above description is only an example and the scope of the disclosure is not limited thereto.

As used herein, a ‘consultant’ may refer to a person who listens to a user's request and consults the user about the request. For example, when a consultation center is operated by a financial service provider, a consultant may refer to a person who monitors a plurality of consultation sessions conducted by chatbots and performs consultation with respect to a consultation session selected during the monitoring of the plurality of consultation sessions in place of an existing respondent. In an alternative embodiment, a consultant may refer to a person who monitors consultation sessions conducted by other consultants or chatbots and performs consultation with respect to a consultation session selected during the monitoring of the consultation sessions in place of an existing respondent.

As used herein, a ‘chatbot’ refers to a device that appropriately handles a user's request and may be understood to mean a virtual respondent provided by the chatbot server 400. In one embodiment, a chatbot may analyze a user's request and provide an appropriate response thereto by using a trained artificial neural network. In another embodiment, the chatbot may classify a user's request, based on preset rules, and provide a response according to a result of the classification. However, the above description is only an example and the scope of the disclosure is not limited thereto.

As used herein, the term ‘respondent’ who responds to a user may be used to include a consultant and a chatbot as described above. Therefore, the respondent may refer to a chatbot or a consultant in some cases.

As used herein, a ‘communication method’ may refer to a means for mediating a conversation between a user and a respondent. For example, the communication method may refer to a voice call method or a chat method. Alternatively, the communication method may refer to a video call method or various means for mediating a conversation between other interlocutors.

In one embodiment, the consultation system may include the first communication network 500A and the second communication network 500B. In this case, the first communication network 500A and the second communication network 500B may refer to communication networks that provide different communication methods.

In one embodiment, the first communication network 500A may refer to a communication network for mediating the exchange of data (or text data) between components of the consultation system. Examples of the first communication network 500A may include wired networks, such as Local Area Networks (LANs), Wide Area Networks (WANs), Metropolitan Area Networks (MANs) and Integrated Service Digital Networks (ISDNs), or wireless networks such as wireless LANs, Code Division Multiple Access (CDMA), Bluetooth, and satellite communication, but the scope of the disclosure is not limited thereto.

In one embodiment, the second communication network 500B may refer to a communication network for mediating the exchange of a voice signal between components of the consultation system. For example, the second communication network 500B may include a Public Switched Telephone Network (PSTN) but the scope of the disclosure is not limited thereto. In this case, the voice signal may refer to a signal transmitted from a user to a respondent or from the respondent to the user according to a ‘voice call method’.

In an alternative embodiment, the first communication network 500A and the second communication network 500B may be configured as one integrated communication network. In this case, the voice signal may be quantized (or digitized) and transmitted or received in the form of voice data.

In another embodiment, the first communication network 500A and the second communication network 500B may be configured to share at least some network configurations.

In one embodiment, the user terminal 200 may refer to various devices that a user uses to deliver his or her request to a consultation center. In other words, the user terminal 200 according to an embodiment may refer to various devices for transmission of details of consultation with a user to the server 100.

As illustrated in FIG. 1, the user terminal 200 may refer to a portable terminal 201, 202 or 203 or a computer 204. Although not shown in FIG. 1, the user terminal 200 may refer to a telephone (not shown) for transmitting a user's voice signal.

In one embodiment, the user terminal 200 may refer to a device through which both a voice call and chatting may be conducted. For example, the user terminal 200 may be the mobile phone 201 which is a device through which both a voice call and chatting may be conducted using the first communication network 500A and/or the second communication network 500B. In this case, the voice call may refer to a conversation held between a user and a respondent using voice. In addition, chatting may refer to a conversation held between a user and a respondent using text messages.

The user terminal 200 may include a display means for displaying content and the like to perform the above-described functions and an input means for receiving an input from a user with respect to such content. In this case, the input means and the display means may be configured in various ways. Examples of the input means may include, but are not limited to, a keyboard, a mouse, a trackball, a microphone, a button, a touch panel, and the like.

In one embodiment, the consultant terminal 300 may refer to various devices used by a consultant to handle (or intervene in) consultation with a user by referring to various information about consultation provided from the server 100.

For example, the consultant terminal 300 according to an embodiment may integrate information about at least one consultation session managed by an individual respondent such as a chatbot and/or another consultant, and display a result of the integration.

As illustrated in FIG. 1, the consultant terminal 300 may include a computer and a voice communication device, through which both a voice call and chatting may be conducted using the first communication network 500A and/or the second communication network 500B. In this case, the voice call may refer to a conversation held between a user and a respondent using voice as described above. In addition, chatting may refer to a conversation held between a user and a respondent using text messages.

In the consultation system according to an embodiment, a plurality of consultant terminals 300 may be provided as illustrated in FIG. 1. However, the number of the consultant terminals 300 illustrated in FIG. 1 is merely an example and thus the scope of the disclosure is not limited thereto.

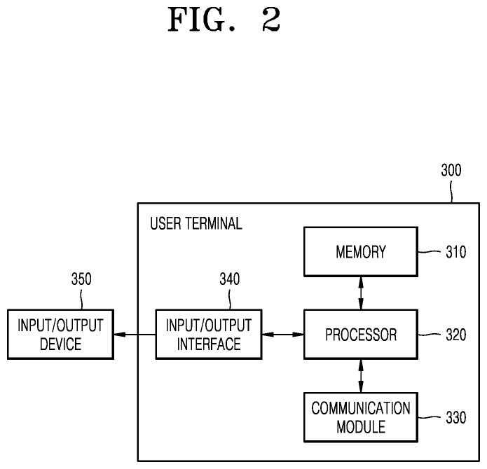

A configuration of the consultant terminal 300 will be described with reference to FIG. 2 below.

The chatbot server 400 according to an embodiment may refer to a computing device that provides a chatbot for providing appropriate feedback to a user according to consultation with the user and performing appropriate processing accordingly. A plurality of chatbot servers 400 may be provided as illustrated in FIG. 1 or one chatbot 400 may be provided.

An artificial neural network model or trained rules for an operation of chatbots may be stored in a memory (not shown) of the chatbot server 400. However, the above description is merely an example and the scope of the disclosure is not limited thereto.

In an alternative embodiment, the chatbot server 400 and the server 100, which will be described below, may be integrally configured. However, for convenience of explanation, it will be hereinafter assumed that the chatbot server 400 and the server 100 are separate devices.

FIG. 2 is a diagram schematically illustrating a configuration of a consultant terminal 300 according to an embodiment.

Referring to FIG. 2, the consultant terminal 300 according to an embodiment may include a memory 310, a processor 320, a communication module 330, and an input/output interface 340, and may be connected to an input/output device 350.

The memory 310 temporarily or permanently stores data processed by the consultant terminal 300. The memory 310 may include a magnetic storage medium or a flash storage medium but the scope of the disclosure is not limited thereto.

The processor 320 may include various types of devices capable of processing data. As used herein, a ‘processor’ may refer to a data processing device embedded in hardware and including a circuit physically configured to, for example, perform a function represented by code or instructions included in a program. Examples of the data processing device embedded in hardware may include processing devices such as a microprocessor, a central processing unit (CPU), a processor core, a multi-processor, an application-specific integrated circuit (ASIC), and a field programmable gate array (FPGA), but the scope of the disclosure is not limited thereto.

The communication module 330 may be a device which includes hardware and software necessary for the consultant terminal 300 to transmit and receive signals, such as a control signal or data signals, by being connected to other network devices, such as the server 100 and/or the user terminal 200, via wire or wirelessly.

The input/output interface 340 may be a means for interfacing with the input/output device 350. Examples of the input device 350 may include devices such as a keyboard, a mouse, and a touch panel. Examples of the output device 350 may include devices such as a display and a speaker.

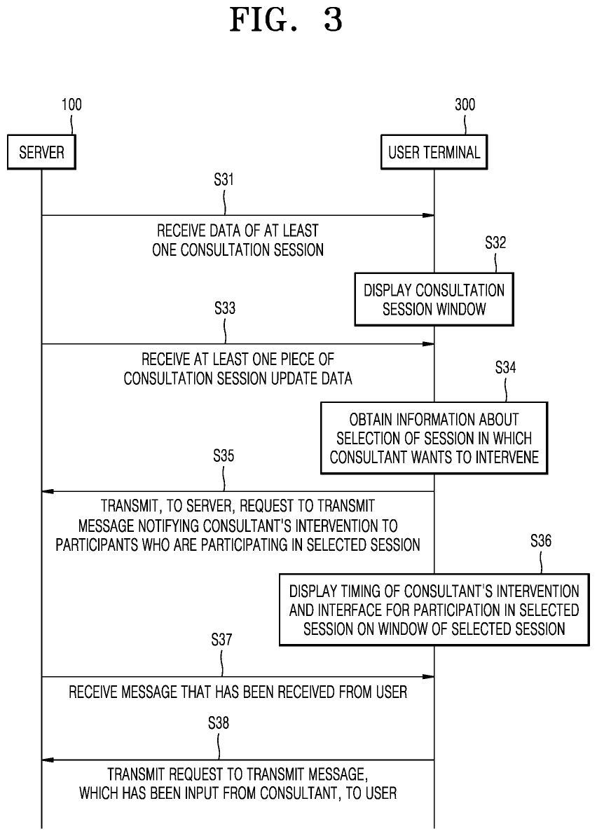

A method of controlling display of a consultation session conducted by the consultant terminal 300 will be described with reference to FIGS. 3 to 6 below.

FIG. 3 is a flowchart for explaining a method of controlling display of a consultation session conducted by a consultant terminal according to an embodiment.

A consultant terminal 300 according to an embodiment may receive data of at least one consultation session to be displayed from the server 100 (S31).For example, the consultant terminal 300 may receive, from the server 100, data of three consultation sessions which are being handled by chatbots. In this case, the “data of the three consultation sessions” may refer to data of consultation sessions for three users. In other words, the consultant terminal 300 may receive data about consultation sessions for three users and simultaneously monitor status of consultation with the three users.

The number of consultation sessions to be received from the server 100 via the consultant terminal 300 may be appropriately determined according to the type and/or status of a consultation system.

For example, the server 100 may determine the number of consultation sessions to equally distribute consultation sessions currently being processed to all consultants, so that data about the determined number of consultation sessions may be received by consultant terminals 300 of the consultants.

In an alternative embodiment, the server 100 may allocate consultation sessions such that the sum of weights of consultation sessions to be burdened on each individual consultant is the same. In this case, the server 100 may assign a high weight to consultation sessions with a higher need for intervention and a low weight to consultation sessions with a lower need for intervention, based on a result of analyzing individual consultation sessions, so that a consultant in charge of a consultation session with a higher need for intervention may be assigned a relatively small number of consultation sessions.

In another alternative embodiment, the server 100 may allocate consultation sessions by taking into consideration professional fields of individual consultants. In this case, the server 100 may allocate consultation sessions such that identified categories of consultation and professional fields of individual consultants match each other, based on a result of analyzing individual consultation sessions.

However, the method of determining the number of consultation sessions and the method of allocating consultation sessions are merely examples and the scope of the disclosure is not limited thereto.

The consultant terminal 300 according to an embodiment may display a consultation session window with respect to each of the at least one consultation session, the consultation session window including history of conversion in each of at least one consultation session (S32).

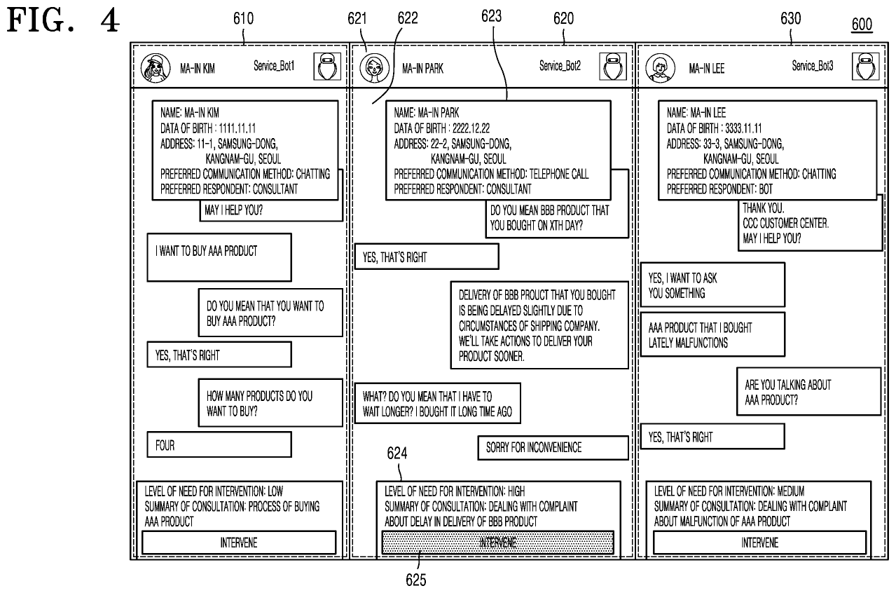

FIG. 4 is a diagram illustrating a screen 600 displayed on a consultant terminal 300, the screen 600 including three consultation session windows 610, 620 and 630.

Referring to FIG. 4, the consultation session windows 610, 620, and 630 with respect to received consultation sessions may be displayed on the screen 600. In this case, each of the consultation session windows 610, 620, and 630 may include areas displaying various information including a history of conversation.

For example, the second consultation session window 620 will be explained as an example below. The second consultation session window 620 includes an area 621 displaying a user and a current respondent, an area 622 displaying history of conversation, an area 623 displaying identification information of the user, and an area 624 displaying a result of analyzing a consultation session, including a level of need for intervention.

In one embodiment, the area 623 displaying the identification information of the user may be displayed as an upper layer of the area 622 displaying the history of conversation. However, the display form of these areas is merely an example and the scope of the disclosure is not limited thereto.

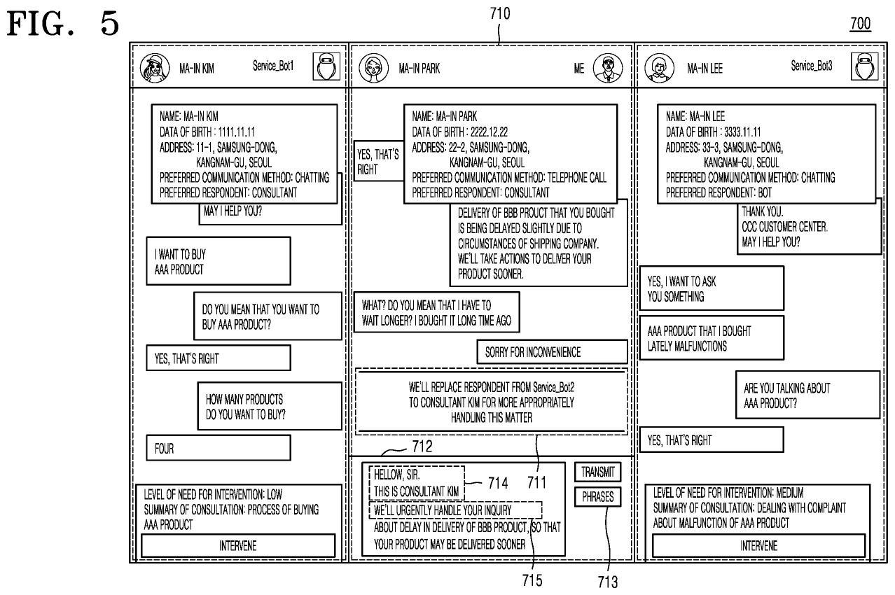

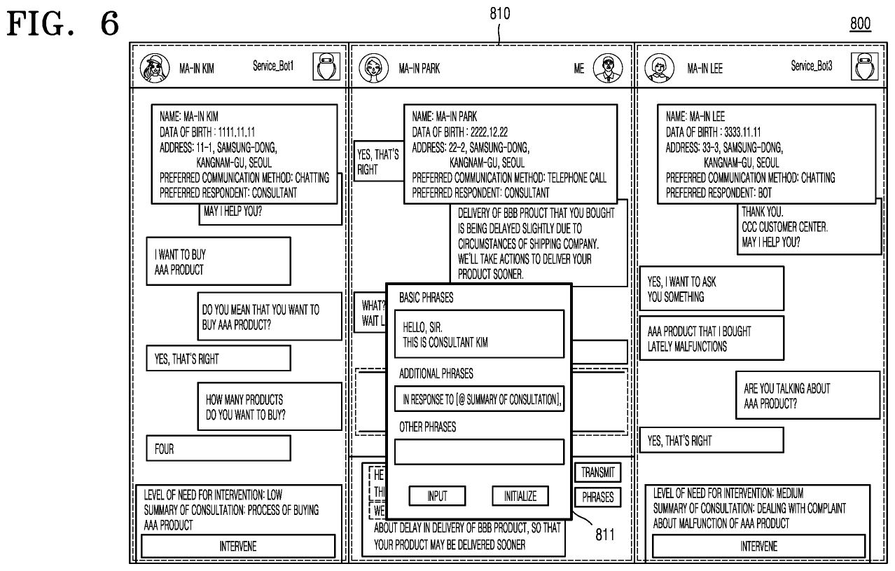

In one embodiment, the area 624 displaying the result of analyzing the consultation session, including the level of need for intervention, may include an interface for a consultant's intervention in a consultation session. For example, the area 624 may include an interface for intervention in a consultation session, e.g., an ‘intervene’ button 625, as illustrated in FIG. 4. However, the above description is merely an example and the scope of the disclosure is not limited thereto. Details of controlling display according to a consultant's intervention will be described with reference to FIGS. 5 and 6 below.

The consultant terminal 300 according to an embodiment may display the consultation session windows 610, 620, and 630 such that at least some areas of each of the consultation session windows 610, 620, and 630 are not hidden by other windows.

In this case, the consultant terminal 300 according to an embodiment may determine areas to be hidden by other windows and/or an area to be lastly displayed, in consideration of display priorities assigned to the areas of the consultation session windows 610, 620 and 630. For example, the consultation session window 620 may be set such that highest priority may be assigned to the area 624, and priorities may be assigned in the order of a region of the area 622, which displays a latest message, the area 621, and the area 623. According to this configuration, the area 624 displaying a result of analyzing a consultation session may always be displayed even when the number of consultation session windows to be displayed increases.

In embodiments, a ‘need for intervention’ may be calculated by the server 100 according to a certain rule and may refer to an index indicating a level of need for a consultant's intervention in a corresponding consultation session.

For example, when a consultation session corresponds to a certain scenario, the server 100 may increase and/or reduce the level of need for intervention. In this case, the scenario may include, for example, a case in which a user's emotional state is an angry state, a case in which the user requests to change a respondent, a case in which the user's request cannot be handled by a chatbot, and the like. However, the above description is merely an example, and a level of need for intervention may be calculated according to various techniques.

The consultant terminal 300 according to an embodiment may display a consultation session display window by adjusting a display method of the consultation session display window according to a level of need for intervention in each consultation session. To this end, the consultant terminal 300 may check a level of need for a consultant's intervention in each of at least one consultation session. In this case, the ‘level of need for intervention’ may be calculated and transmitted by the server 100 as described above.

The consultant terminal 300 according to an embodiment may emphasize and display a session window when a level of need for intervention in a consultation session is high.

In this case, as illustrated in FIG. 4, the ‘emphasizing and displaying’ of the session window may be understood to mean displaying the session window by displaying a display size (width) of each of the consultation session windows 610, 620 and 630 in proportion to a level of need for intervention, displaying the session window on a highest layer, displaying the session window at the front, and blinking the session window. However, the above-described methods are examples of a method of emphasizing and displaying a session window, and the ‘emphasizing and displaying’ of the session window according to an embodiment may include various methods of visually emphasizing and displaying a certain object on a screen.

The consultant terminal 300 according to an embodiment may adjust a degree of emphasis of a consultation session window or change a window to be emphasized whenever consultation session data and/or a level of need for intervention is updated over time.

For example, the consultant terminal 300 according to an embodiment may receive at least one piece of consultation session update data (S33), and update and display an emphasis display, based on the received consultation session update data. The receiving of the at least one piece of consultation session update data in operation S33 may be performed in parallel with other operations.

That is, for convenience of explanation, it has been described above with reference to FIG. 3 that the receiving of the at least one piece of consultation session update data is performed between operations S32 and S34, but the receiving of the at least one piece of consultation session update data may be performed in parallel with operations S34 to S38 regardless of an execution order.

The consultant terminal 300 according to an embodiment may display a session window of a consultation session, which satisfies a certain condition for a consultant's intervention, in a preset manner, based on the at least one piece of the consultation session update data received in operation S33. In this case, the ‘condition for a consultant's intervention’ may be, for example, a condition in which the ‘level of need for intervention’ described above is equal to or greater than a certain threshold.

For example, when a level of need for intervention in a second consultation session indicated by the second consultation session window 620 of FIG. 4 is equal to or greater than the threshold, the consultant terminal 300 may change a color of the ‘intervene’ button 625 on the second consultation session window 620 to be different from those of the other consultation session windows 610 and 630 or may alternately display two different colors. However, the above description is merely an example and the scope of the disclosure is not limited thereto.

The consultant terminal 300 according to an embodiment may perform a process for a consultant's intervention in a selected consultation session, based on information about a consultant's selection of one of at least one consultation session displayed on a screen.

For example, the consultant may select and intervene in a second consultation session by performing an input using the ‘intervene’ button 625 on the second consultation session window 620.

To this end, the consultant terminal 300 according to an embodiment may obtain information about selection of a session in which a consultant wants to intervene (S34),In addition, the consultant terminal 300 may perform a series of processing for the consultant's intervention in the selected consultation session.

First, the consultant terminal 300 according to an embodiment may transmit, to the server 100, a request to transmit a message providing notification of the consultant's intervention to at least one of a respondent and a user who are participating in the selected consultation session (S35). In this case, the consultant terminal 300 may transmit to the server 100 an instruction to instructing an existing respondent (e.g., a chatbot) to end answering to a user.

Alternatively, timing of the consultant's intervention and an interface for the consultant's participation in the selected consultation session may be displayed on a chat window of the selected consultation session (S36).

FIGS. 5 and 6 illustrate screens 700 and 800 which are examples of a screen displaying an interface for a consultant's participation in a session.

For convenience of explanation, it will be assumed that a consultant has requested to intervene in a second consultation session by performing an input using the ‘intervene’ button 625 on the screen of FIG. 4.

Under the above assumption, the consultant terminal 300 according to an embodiment may display, on a consultation session window 710, timing of the consultant's intervention in the form of a certain message 711 and an interface 712 for the consultant's participation in a session.

In this case, the message 711 indicating the timing of the consultant's intervention may be displayed in an area of the consultation session window 710, which displays history of conversation, so that the timing of the consultant's intervention may be accurately displayed and the consultant may be allowed to intervene by referring to the context of the history of conversation.

The interface 712 may include a region displaying messages input by the consultant, a button for transmitting messages, and a button 713 for inputting pre-completed phrases 714 and 715. A user may input a message through an input means such as a keyboard or may input the pre-completed phrases 714 and 715 by clicking the button 713.

When the user inputs a phrase by clicking the button 713, the consultant terminal 300 according to an embodiment may display a layer 811 for inputting phrases on a consultation session window 810 as shown in FIG. 6. In this case, the consultant terminal 300 may basically display an interface for inputting ‘basic phrases’ available in all consultation sessions, an interface for inputting ‘additional phrases’ that are available in all consultation sessions but need to be changed, and an interface for inputting ‘other phrases’. A user may quickly create and transmit a first message through an interface displayed on the layer 811, thereby minimizing inconvenience that may be caused to the user due to a change of a respondent.

The consultant terminal 300 according to an embodiment may receive a message, which has been received from a user, from the server 100 and display the message (S37), and obtain a message input by a consultant in response to the message from the user and transmit the obtained message to the server 100 so as to request the obtained message to be transmitted to the user's terminal (S38).

Accordingly, according to embodiments, a plurality of consultation sessions may be monitored by a consultant, and in particular, a consultation session window may be displayed by giving a visual effect thereto according to a level of need for intervention in each of the plurality of consultation sessions, thereby enabling the consultant to efficiently monitor the plurality of consultation sessions.

According to embodiments, an interface for quickly inputting a pre-completed phrase for a consultant's intervention in a consultation session, thereby preventing a delay in consultation due to a change of a respondent.

Furthermore, a consultation center may be operated by using chatbots as a plurality of respondents and allowing a consultant to intervene in only for a few consultation sessions with the need for intervention, thereby reducing the size and maintenance costs of the consultation center.

The embodiments described above may be embodied in the form of a computer program executable through various components in a computer, and the computer program may be recorded in a computer-readable recording medium. In this case, the computer-readable recording medium may store programs executable by a computer. Examples of the computer-readable recording medium include a magnetic medium such as a hard disc, a floppy disk and a magnetic tape, an optical recording medium such as a compact disc (CD)-read-only memory (ROM) and a digital versatile disk (DVD), a magneto-optical medium such as a floptical disk, a ROM, a random access memory (RAM), a flash memory, and the like, and may be configured to store program instructions.

The programs executable by a computer may be specially designed and configured for embodiments or may be well-known and available by those of ordinary skill in the field of computer software. Examples of the programs include not only machine code created by a compiler but also high-level language code executable by a computer using an interpreter or the like.

The embodiments described herein are only examples and thus the scope of the disclosure is not limited thereby in any way. For brevity of the specification, a description of existing electronic configurations, control systems, software, and other functional aspects of the systems may be omitted. Lines or members connecting components illustrated in the drawings are illustrative of functional connections and/or physical or circuit connections between the components and thus are replaceable or various functional, physical or circuit connections may be added in an actual device. Unless a component is specifically stated with an expression “essential”, “important”, or the like, the component may not be an essential component for application of embodiments.

Therefore, the scope of the disclosure should not be construed as being limited to the above-described embodiments, and the scope of all embodiments equivalent to the scope of the claims described below or equivalently changed from the claims are within the scope of the disclosure.

According to embodiments, information related to consultation may be integrated and provided to a consultant to use resources of a consultation center more efficiently and to enable the consultant to conduct consultation effectively.

A history of conversation with previous consultation targets may be provided to minimize inconvenience, which may be caused to a user due to duplicate consultation, when consultation is conducted with respect to various consultation targets in one consultation session.

Information related to a user's psychological state and the like may be provided to a consultant through a history of conversation and relevant information may be provided in real time according to the history of conversation, so that consultation may be conducted effectively and intensively and conducted to meet the user's need.

A consultation center may be operated by using chatbots as a plurality of respondents and allowing a consultant to intervene in only for a few consultation sessions with the need for intervention, thereby reducing the size and maintenance costs of the consultation center.

A plurality of consultation sessions may be monitored by a consultant, and in particular, a consultation session window may be displayed by giving visual effects thereto according to levels of need for intervention in the plurality of consultation sessions, thereby enabling the consultant to efficiently monitor the plurality of consultation sessions.

In addition, an interface for quickly inputting a pre-completed phrase for a consultant's intervention in a consultation session may be provided to prevent a delay in consultation due to a change of a respondent.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A method of controlling display of a consultation session by integrating and displaying at least one consultation session managed by an individual respondent, the method comprising:
receiving, from a server, data about the at least one consultation session to be displayed;
displaying a consultation session window for each of the at least one consultation session, the consultation session window including a history of conversation in each of the at least one consultation session; and
displaying in a preset manner a session window of a consultation session in which details of consultation satisfy a certain condition for a consultant's intervention.

2. The method of claim 1, further comprising performing processing for the consultant's intervention in a selected consultation session, based on information regarding the consultant's selection of one of the at least one consultation session.

3. The method of claim 2, wherein the step of performing the processing for the consultant's intervention further comprises:
requesting the server to transmit a message providing notification of the consultant's intervention to at least one of a respondent and a user who participate in the selected consultation session;
displaying timing of the consultant's intervention on a conversation window of the selected consultation session; and
displaying an interface for the consultant's participation in the selected consultation session.

4. The method of claim 3, wherein the step of performing the processing for the consultant's intervention further comprises transmitting, to the server, an instruction instructing the respondent to end answering to the user.

5. The method of claim 1, wherein the step of displaying the consultation session window further comprises displaying a consultation session display window for each of the at least one consultation session such that at least some areas of the consultation session are not hidden by other windows.

6. The method of claim 1, wherein the step of displaying the session window of the consultation session in the preset manner further comprises:
checking a level of need for the consultant's intervention in each of the at least one consultation session; and
emphasizing and displaying a session window of a consultation session with a higher need for the consultant's intervention.

7. The method of claim 6, wherein the step of emphasizing and displaying of the session window of the consultation session further comprises displaying the session window of the consultation session with the higher need for the consultant's intervention by displaying the session window to be larger, displaying the session window at a highest layer, displaying the session window at the front, or blinking the session window.

8. The method of claim 1, wherein the condition for the consultant's intervention comprises a condition in which a level of need for the consultant's intervention is equal to or greater than a certain threshold.

9. The method of claim 1, wherein the step of displaying the consultation session window further comprises displaying, on the consultation session window, at least one of identification information of a user participating in the at least one consultation session, information obtained by analyzing the history of conversation, and additional information of the user, as well as the history of conversation in each of the at least one consultation session.
